(19) United States
(12) Patent Application Publication
(10) Pub. No.: US 2011/0034211 A1
(43) Pub. Date: Feb. 10, 2011

(54) COMMUNICATION DEVICE AND START UP METHOD THEREOF

(75) Inventor: JUN LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/639,160

(22) Filed: Dec. 16, 2009

(30) Foreign Application Priority Data
Aug. 6, 2009 (CN) 200910305287.8

(51) Int. Cl. H04B 1/38

(52) U.S. Cl. 455/558

(57) ABSTRACT

A communication device and a starting up method include determining if the communication device has been locked with a designated subscriber identification module (SIM) card, and determining if an acquired unique International Mobile Subscriber Identity (IMSI) code of a current SIM card matches a prestored IMSI code of the designated SIM card when the communication device has been locked with a designated SIM card. The communication device and method further include unlocking the designated SIM card with the communication device if the acquired IMSI code does not match the prestored IMSI code, and starting up the communication device.

### BACKGROUND

1. Technical Field

Embodiments of the present disclosure relate to protecting a communication device, and more particularly to a communication device and method for starting up the communication device.

2. Description of Related Art

A communication device may have one or more removable subscriber identification module (SIM) cards. In case that the communication device is lost, other people may reuse the communication device by replacing an original SIM card in the communication device with another SIM card. Thus, when the communication device starts up, it uses data from another SIM card rather than the original SIM card, which may cause security concerns.

What is needed, therefore, is an improved communication device and method for starting up the communication device by verifying a SIM card of the communication device.

### BRIEF DESCRIPTION OF THE DRAWINGS

FIG. 1 is a block diagram of one embodiment of a communication device including a protecting system.

FIG. 2 is a block diagram of one embodiment of the protecting system.

FIG. 3 is a flowchart of one embodiment of a method for starting up the communication device of FIG. 1.

FIG. 4 is a flowchart of one embodiment of a method for locking a SIM card with the communication device of FIG. 1.

FIG. 5 is a flowchart of one embodiment of a method for unlocking a designated SIM card with the communication device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

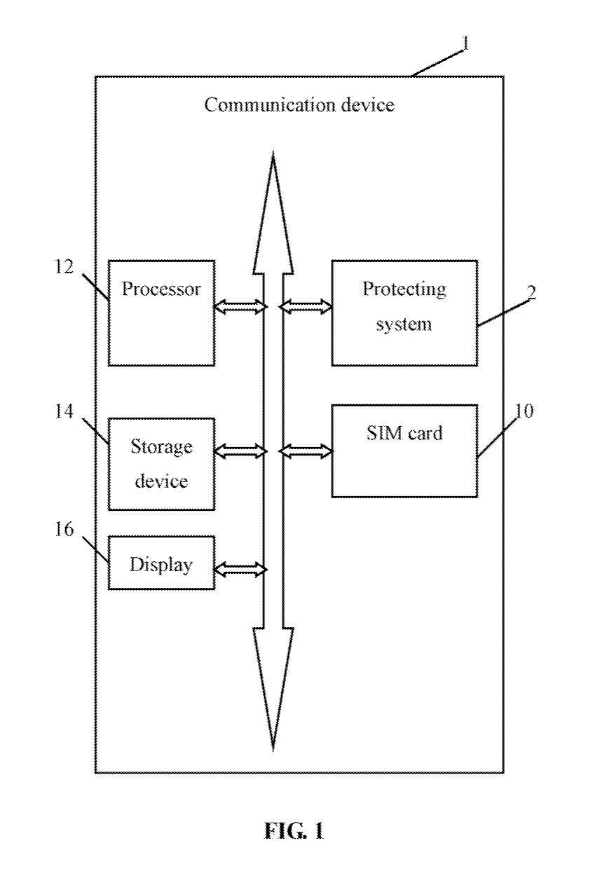

FIG. 1 is a block diagram of one embodiment of a communication device 1 including a protecting system 2. The protecting system 2 may be used to lock a designated subscriber identification module (SIM) card with the communication device 1. When the communication device 1 is powered on, the protecting system 2 may detect if a SIM card 10 of the communication device 1 is the designated SIM card. If the SIM card 10 is the designated SIM card, the communication device 1 may start up, and grant access to the communication device 1. If the SIM card 10 is not the designated SIM card, identification needs to be done by verifying if an input password matches a preset lock password. Detail operations will be provided below.

In one embodiment, when the communication device 1 is in an abnormal state, for example, the communication device 1 is lost or stolen, a SIM card (e.g., the designated SIM card) of the communication device 1 may be replaced. Then the communication device 1 cannot start up normally if people replaced the SIM card do not know the preset lock password. That is, other people (e.g., a thief) cannot use the communication device 1 by merely replacing the SIM card 10 of the communication device.

The communication device 1 may be a mobile phone, a personal digital assistant, a handheld computer, or any other kind of electronic device. The communication device 1 also includes a processor 12, a storage system 14, and a display 16. The processor 12 executes one or more computerized operations of the communication device 1 and other applications, to provide the functions of the communication device 1. The storage system 14 stores one or more programs, such as programs of the operating system, other applications of the communication device 1, and various kinds of data, messages, or E-mails, for example. In one embodiment, the communication device 1 may be a mobile phone, and the storage system 14 may be a memory of the communication device 1 or an external storage card, such as a memory stick, a smart media card, a compact flash card, or any other type of memory card. The display 16 may display various information, such as the messages, and user interfaces provided by the communication device 1, for example.

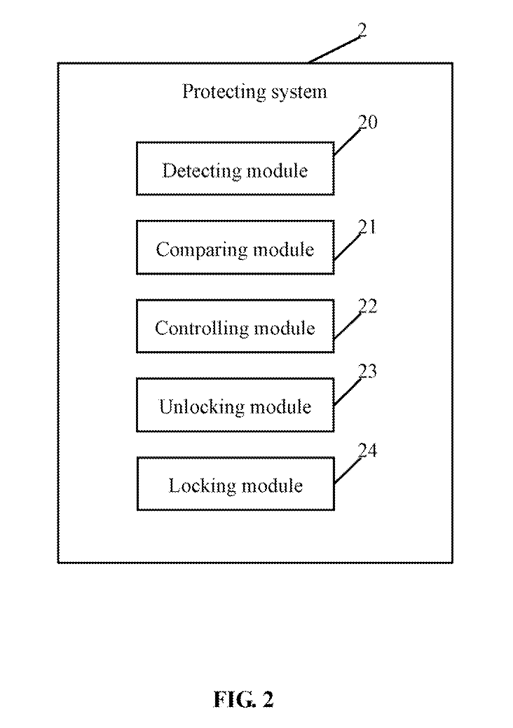

FIG. 2 is a block diagram of one embodiment of the protecting system 2. In one embodiment, the protecting system 2 includes a detecting module 20, a comparing module 21, a controlling module 22, an unlocking module 23, and a locking module 24. The modules 20-24 may comprise one or more computerized codes to be executed by the processor 12 to perform one or more operations of the communication device 1. Details of these operations will be provided below.

In one embodiment, a designated SIM card may be locked to the communication device 1. The locking module 24 is operable to preset a lock password to lock the designated SIM card to the communication device 1 in response to receiving a password setting via a keyboard or a touch screen of the communication device 1. The locking module 24 further acquires a unique international mobile subscriber identity (IMSI) code of the designated SIM card. It should be understood that each SIM card has an IMSI code, which is read by a communication device when powered on. In one embodiment, if the lock password is preset successfully, the designated SIM card becomes locked to the communication device 1.

The locking module 24 stores the acquired IMSI code and the preset lock password into the storage device 14. The locking module 24 may further display a SIM card locked indicator on the display 16 of the communication device 1. In one embodiment, the SIM card locked indicator may be an icon, for example.

The detecting module 20 receives powered on signals from the communication device 1, and determines if the communication device 1 has been locked with a designated SIM card by determining if the communication device 1 has a preset lock password. If the communication device 1 has the preset lock password, the detecting module 20 determines that the communication device 1 has been locked with a designated SIM card.

If the communication device 1 has not been locked with a designated SIM card, the controlling module 22 starts up the communication device 1 normally.

If the communication device 1 has been locked with a designated SIM card, the comparing module 21 acquires/reads an IMSI code of the SIM card 10. The comparing module 21 determines if the acquired IMSI code of the SIM card 10 matches the prestored IMSI code of the designated SIM card in the storage device 14.

If the acquired IMSI code matches the prestored IMSI code, the controlling module 22 starts up the communication device 1.

If the acquired IMSI code does not match the prestored IMSI code, the unlocking module 23 may unlock the designated SIM card with the communication device 1. Firstly, the unlocking module 23 prompts a user of the communication device 1 to input a password, and receives the input password via the keyboard or the touch screen of the communication device 1. The unlocking module 23 determines if the input password matches the preset lock password.

If the input password matches the preset lock password, the unlocking module 23 deletes the prestored IMSI code of the designated SIM card in the storage device 14, and clears the preset lock password to unlock the designated SIM card with the communication device 1. Then the controlling module 22 starts up the communication device 1 when the designated SIM card is unlocked with the communication device 1.

If the input password does not match the preset lock password, the unlocking module 23 prompts that the designated SIM card fails to unlock with the communication device 1, and displays a message on the display 16 to prompt that the SIM card 10 cannot be used. Then the controlling module 22 powers off the communication device 1.

In another embodiment, the unlocking module 23 may be further operable to preset a maximum password input attempt to limit unlocking attempt failures of invalid passwords. The unlocking module 23 further counts the unlocking attempt failure, and determines if the unlocking attempt failure is equal to the preset maximum password input attempt.

If the unlocking attempt failure is equal to the preset maximum password input attempt, the unlocking module 23 prompts that the designated SIM card fails to unlock with the communication device 1. Then the controlling module 22 powers off the communication device 1. If the unlocking attempt failure is less than the preset maximum password input attempt, the unlocking module 23 prompts the user to input a password until the unlocking attempt failure is equal to the preset maximum password input attempt or the inputted password is verified to valid.

In addition, if the communication device 1 is not locked with any designated SIM card, or if the designated SIM card is unlocked with the communication device 1, the SIM card 10 may be selected to lock with the communication device 1 according to user requirements.

As mentioned above, if the SIM card 10 needs to be locked with the communication device 1, the locking module 24 prompt the user to preset a lock password to lock the SIM card 10 with the communication device 1. Then the locking module 24 stores the acquired IMSI code of the SIM card 10 into the storage device 14. If the SIM card 10 is replaced by other people, who do not know the preset lock password, the communication device 1 cannot start up normally.

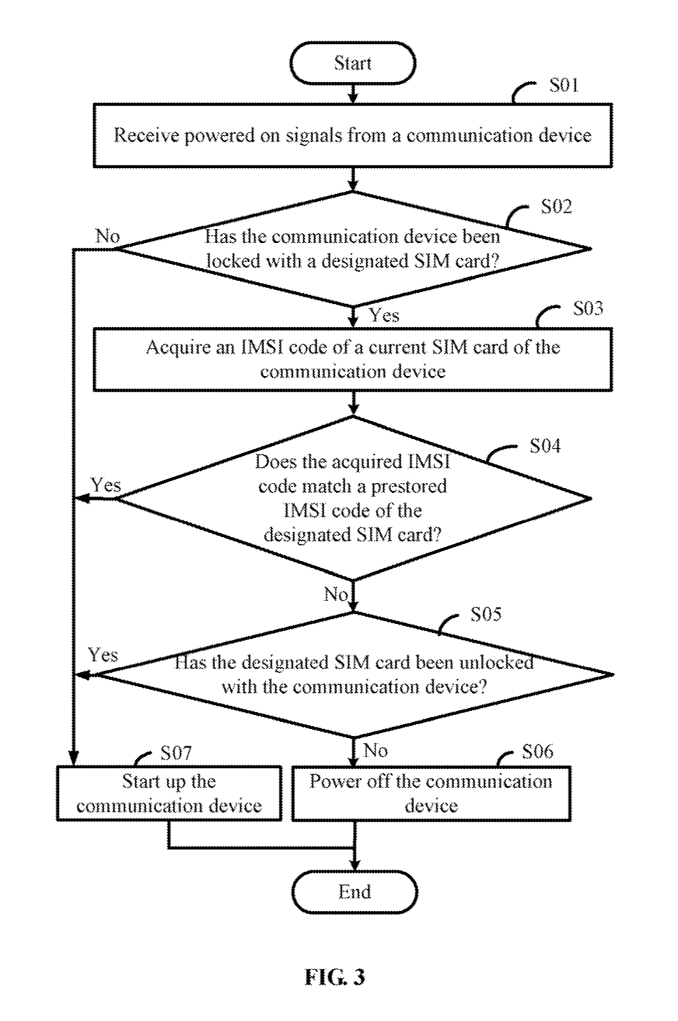

FIG. 3 is a flowchart of one embodiment of a method for starting up the communication device 1 of FIG. 1. Depending on the embodiment, additional blocks may be added, others removed, and the ordering of the blocks may be replaced.

In block S2, the detecting module 20 receives powered on signals from the communication device 1.

In block S4, the detecting module 20 determines if the communication device 1 has been locked with a designated SIM card by determining if the communication device 1 has a preset lock password. Detailed operations on presetting the lock password to lock the designated SIM card to the communication device 1 is provided in FIG. 2 as mentioned above.

If the communication device 1 has not been locked with the designated SIM card, in block S07, the controlling module 22 starts up the communication device 1 normally.

If the communication device 1 has been locked with the designated SIM card, in block S03, the comparing module 21 acquires an IMSI code of the SIM card 10.

In block S04, the comparing module 21 determines if the acquired IMSI code of the SIM card 10 matches a prestored IMSI code of the designated SIM card in the storage device 14.

If the acquired IMSI code matches the prestored IMSI code, the procedure goes to block S07 directly.

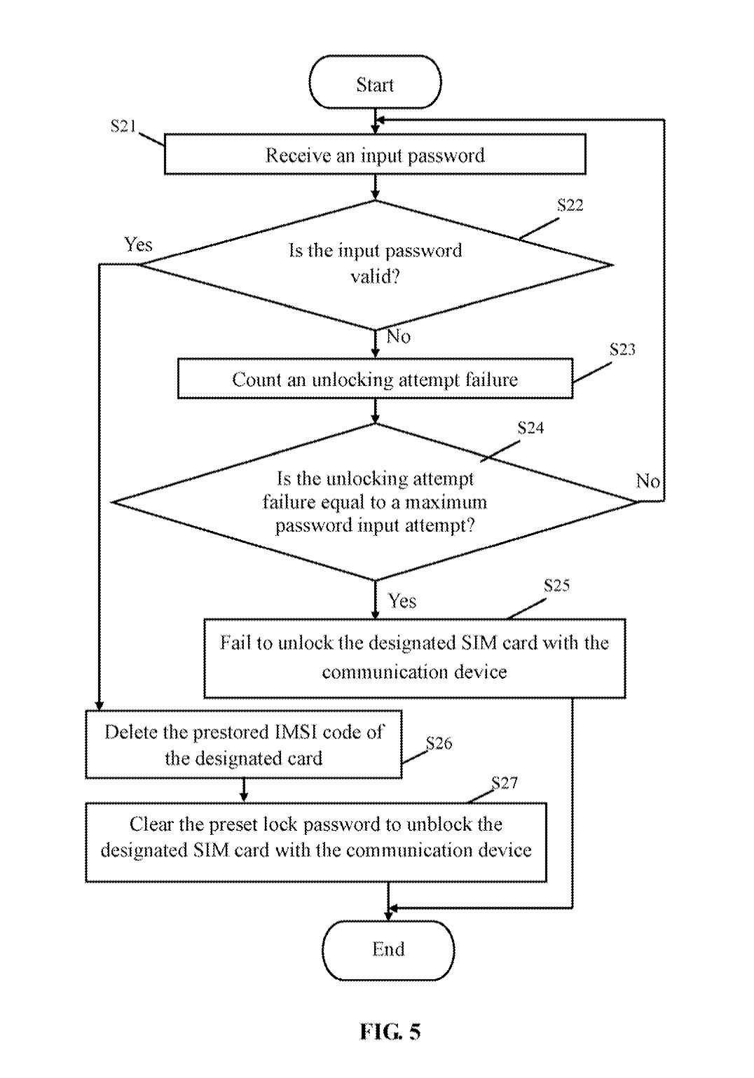

If the acquired IMSI code does not match the prestored IMSI code, in block S05, the unlocking module 23 determines if the designated SIM card is unlocked with the communication device 1. Detailed operations on unlocking the designated SIM card with the communication device 1 will be described in FIG. 5.

If the designated SIM card is unlocked with the communication device 1, the procedure goes to block S07 directly.

If the designated SIM card is not unlocked with the communication device 1, in block S06, the controlling module 22 powers off the communication device 1.

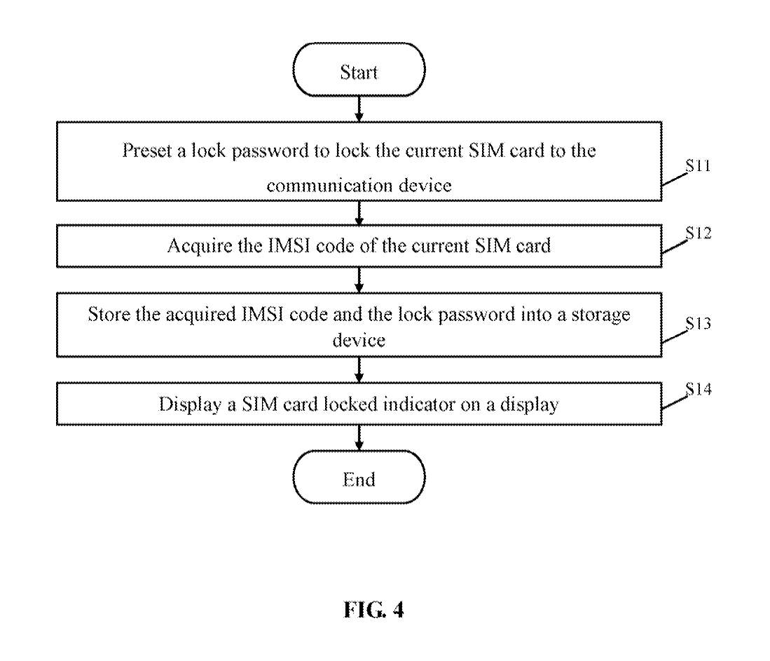

FIG. 4 is a flowchart of one embodiment of a method for locking the SIM card 10 with the communication device 1 of FIG. 1. If the communication device 1 is not locked with any designated SIM card, or if the designated SIM card has been unlocked with the communication device 1, the SIM card 10 may be selected to lock to the communication device 1 according to user requirements. Depending on the embodiment, additional blocks may be added, others removed, and the ordering of the blocks may be replaced.

As mentioned above, if the SIM card 10 needs to be locked to the communication device 1, in block S11, the locking module 24 prompt the user to preset a lock password to lock the SIM card 10 to the communication device 1.

In block S12, the locking module 24 acquires the IMSI code of the SIM card 10.

In block S13, the locking module 24 stores the acquired IMSI code of the SIM card 10 and the preset lock password into the storage device 14.

In block S14, the locking module 24 displays a SIM card locked indicator on the display 16 of the communication device 1.

FIG. 5 is a flowchart of one embodiment of a method for unlocking the designated SIM card with the communication device 1 of FIG. 1. Depending on the embodiment, additional blocks may be added, others removed, and the ordering of the blocks may be replaced.

In block S21, the unlocking module 23 prompts a user of the communication device 1 to input a password, and receives the input password via the keyboard or the touch screen of the communication device 1.

In block S21, the unlocking module 23 determines if the input password is valid by comparing the input password with the preset lock password.

If the input password is valid, that is, the input password matches the preset lock password, in block S26, the unlocking module 23 deletes the prestored IMSI code of the designated SIM card in the storage device 14. In block S27, the unlocking module 24 clears the preset lock password to unlock the designated SIM card with the communication device 1.

If the input password is not valid, that is, the input password does not match the preset lock password, in block S23, the unlocking module 23 counts an unlocking attempt failure.

In block S24, the unlocking module 23 determines if the unlocking attempt failure is equal to a preset maximum password input attempt.

If the unlocking attempt failure is less than the preset maximum password input attempt, the procedure returns to block S21.

If the unlocking attempt failure is equal to the preset maximum password input attempt, in block S25, the unlocking module 23 prompts that the designated SIM card fails to unlock with the communication device 1, and displays a message on the display 16 to prompt that the SIM card 10 cannot be used.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for starting up a communication device, the communication device comprising a current subscriber identification module (SIM) card, the method comprising:
receiving powered on signals to start up the communication device;
determining if the communication device has been locked with a designated SIM card by determining if the communication device has a preset lock password;
acquiring a unique International Mobile Subscriber Identity (IMSI) code of the current SIM card if the communication device has been locked with the designated SIM card;
determining if the acquired IMSI code matches a prestored IMSI code of the designated SIM card in a storage device of the communication device;
starting up the communication device if the acquired IMSI code matches the prestored IMSI code in the storage device; or
unlocking the designated SIM card with the communication device if the acquired IMSI code does not match the prestored IMSI code in the storage device; and
starting up the communication device if the designated SIM card has been unlocked with the communication device, or powering off the communication device if the designated SIM card has not been unlocked with the communication device.

2. The method according to claim 1, further comprising:
determining that the communication device has been locked with the designated SIM card if the communication device has a preset lock password; or
determining that the communication device has not been locked with the designated SIM card if the communication device has no preset lock password.

3. The method according to claim 1, wherein the step of unlocking the designated SIM card with the communication device comprises:
receiving an input password;
determining if the input password matches the preset lock password; and
deleting the prestored IMSI code of the designated SIM card in the storage device, and clearing the preset lock password to unlock the designated SIM card with the communication device, if the input password matches the preset lock password; or
powering off the communication device if the input password does not match the preset lock password.

4. The method according to claim 1, further comprising:
starting up the communication device if the communication device has not been locked with a designated SIM card.

5. The method according to claim 1, further comprising:
presetting a lock password to lock the current SIM card with the communication device if the communication device has not been locked with a designated SIM card; and
storing the acquired IMSI code into the storage device.

6. The method according to claim 1, wherein the communication device is a mobile phone.

7. A communication device, the communication device comprising:
a current subscriber identification module (SIM) card;
a storage device;
at least one processor;
one or more programs stored in the storage device and being executable by the at least one processor, the one or more programs comprising:
a detecting module operable to receive powered on signals to start up the communication device, determine if the communication device has been locked with a designated SIM card by determining if the communication device has a preset lock password;
a comparing module operable to acquire a unique International Mobile Subscriber Identity (IMSI) code of the current SIM card if the communication device has been locked with the designated SIM card, and determine if the acquired IMSI code matches a prestored IMSI code of the designated SIM card in the storage device;
a controlling module operable to start up the communication device if the acquired IMSI code matches the prestored IMSI code in the storage device;
an unlocking module operable to unlock the designated SIM card with the communication device if the acquired IMSI code does not match the prestored IMSI code in the storage device; and
the controlling module further operable to start up the communication device if the designated SIM card has been unlocked with the communication device, or power off the communication device if the designated SIM card has not been unlocked with the communication device.

8. The communication device according to claim 7, wherein the detecting module determines that the communication device has been locked with the designated SIM card if the communication device has a preset lock password, or determine that the communication device has not been locked with the designated SIM card if the communication device has no preset lock password.

9. The communication device according to claim 7, wherein the unlocking module unlock the designated SIM card with the communication device by:
receiving an input password;
determining if the input password matches the preset lock password; and
deleting the prestored IMSI code of the designated SIM card in the storage device, and clearing the preset lock password to unlock the designated SIM card with the communication device, if the input password matches the preset lock password.

10. The communication device according to claim 9, wherein the controlling module is further operable to power off the communication device if the input password does not match the preset lock password.

11. The communication device according to claim 7, wherein the controlling module is further operable to start up the communication device if the communication device has not been locked with the designated SIM card.

12. The communication device according to claim 7, wherein the one or more programs further comprise a locking module operable to preset a lock password to lock the current SIM card with the communication device, and store the acquired IMSI code into the storage device.

13. The communication device according to claim 7, wherein the communication device is a mobile phone.

14. A storage medium storing a set of instructions, the set of instructions capable of being executed by a processor to perform a method for starting up a communication device, the communication device comprising a current subscriber identification module (SIM) card, the method comprising:
receiving powered on signals to start up the communication device;
determining if the communication device has been locked with a designated SIM card by determining if the communication device has a preset lock password;
acquiring a unique International Mobile Subscriber Identity (IMSI) code of the current SIM card if the communication device has been locked with the designated SIM card;
determining if the acquired IMSI code matches a prestored IMSI code of the designated SIM card in a storage device of the communication device;
starting up the communication device if the acquired IMSI code matches the prestored IMSI code in the storage device; or
unlocking the designated SIM card with the communication device if the acquired IMSI code does not match the prestored IMSI code in the storage device; and
starting up the communication device if the designated SIM card has been unlocked with the communication device, or powering off the communication device if the designated SIM card has not been unlocked with the communication device.

15. The storage medium as claimed in claim 14, wherein the method further comprises:
determining that the communication device has been locked with the designated SIM card if the communication device has a preset lock password; or
determining that the communication device has not been locked with the designated SIM card if the communication device has no preset lock password.

16. The storage medium as claimed in claim 14, wherein the step of unlocking the designated SIM card with the communication device comprises:
receiving an input password;
determining if the input password matches the preset lock password; and
deleting the prestored IMSI code of the designated SIM card in the storage device, and clearing the preset lock password to unlock the designated SIM card with the communication device, if the input password matches the preset lock password; or
powering off the communication device if the input password does not match the preset lock password.

17. The storage medium as claimed in claim 14, wherein the method further comprises:
starting up the communication device if the communication device has not been locked with the designated SIM card.

18. The storage medium as claimed in claim 14, wherein the method further comprises:
presetting a lock password to lock the current SIM card with the communication device if the communication device has not been locked with the designated SIM card; and
storing the acquired IMSI code into the storage device.
